(19) United States
(12) Patent Application Publication
(10) Pub. No.: US 2021/0272520 A1
(43) Pub. Date: Sep. 2, 2021

(54) PIXEL CIRCUIT, DRIVING METHOD THEREOF AND DISPLAY PANEL

(71) Applicant: BOE TECHNOLOGY GROUP CO., LTD., Beijing (CN)

(72) Inventors: Shengji YANG, Beijing (CN); Xiaochuan CHEN, Beijing (CN); Hui WANG, Beijing (CN); Shengnan LI, Beijing (CN)

(21) Appl. No.: 17/252,343

(22) PCT Filed: Apr. 7, 2020
(86) PCT No.: PCT/CN2020/083496

§ 371 Date: Dec. 15, 2020

(30) Foreign Application Priority Data
Jun. 11, 2019 (CN) 201910501372.5

(51) Int. Cl. G09G 3/3258; G09G 3/3291

(52) U.S. Cl. CPC G09G 3/3258; G09G 2300/0426; G09G 3/3291

(57) ABSTRACT

There is a pixel circuit including: a light emitting module a light emitting driving module which drives the light emitting module to emit light; a fingerprint identification module which performs fingerprint identification. The light emitting driving module includes a first data input terminal, a first data input control terminal and a light emitting control terminal; the fingerprint identification module includes an identification signal output terminal, an identification signal output control terminal and an identification driving control terminal, the identification signal output control terminal is electrically coupled to the light emitting control terminal, the identification driving control terminal is electrically coupled to the first data input control terminal, the identification signal output terminal outputs an identification signal under control of signals received by the identification driving control terminal and the identification signal output control terminal. A driving method of the pixel circuit and a display panel are further provided.

### TECHNICAL FIELD

The present disclosure relates to the field of display technology, and in particular, to a pixel circuit, a driving method of the pixel circuit, and a display panel including the pixel circuit.

### BACKGROUND

In order to improve use security, a fingerprint identification module is generally provided in a display panel. The existing fingerprint identification module is generally arranged in the display panel in a superposition mode. With pursuit of consumers for lightness and thinness of the display panel, the fingerprint identification module arranged in the display panel in the superposition manner cannot meet demands in market.

### SUMMARY

As an aspect of the present disclosure, there is provided a pixel circuit including a light emitting module, a light emitting driving module configured to drive the light emitting module to emit light, and a fingerprint identification module configured to perform fingerprint identification, where,

the light emitting driving module includes a first data input terminal, a first data input control terminal and a light emitting control terminal, and is configured to output a driving signal to the light emitting module under the control of signals received by the first data input terminal, the first data input control terminal and the light emitting control terminal;

the fingerprint identification module includes an identification signal output terminal, an identification signal output control terminal and an identification driving control terminal, the identification signal output control terminal is electrically coupled to the light emitting control terminal, the identification driving control terminal is electrically coupled to the first data input control terminal, the identification signal output terminal of the fingerprint identification module is configured to output an identification signal under the control of signals received by the identification driving control terminal and the identification signal output control terminal, and the identification signal output by the fingerprint identification module is influenced by a fingerprint identified by the fingerprint identification module.

In some implementations, the light emitting driving module includes a data writing sub-module, a light emitting control sub-module, a driving sub-module, and a compensation sub-module, a control terminal of the data writing sub-module is electrically coupled to the first data input control terminal, an output terminal of the data writing sub-module is electrically coupled to the driving sub-module, an input terminal of the data writing sub-module is electrically coupled to the first data input terminal, and the input terminal and the output terminal of the data writing sub-module are capable of being electrically coupled with each other in response to that the first data input control terminal receives an effective scanning signal;

a light emitting control module is electrically coupled between the driving sub-module and a high level signal terminal, and/or a light emitting control module is electrically coupled between the driving sub-module and the light emitting module, and a control terminal of the driving sub-module is electrically coupled to the compensation sub-module;

a control terminal of the compensation sub-module is electrically coupled to the first data input control terminal, the compensation sub-module is further electrically coupled to the high level signal terminal, and the compensation sub-module is capable of storing a data voltage input by the data writing sub-module under the control of a signal received by the control terminal of the compensation sub-module.

In some implementations, the driving sub-module includes a driving transistor, a gate electrode of the driving transistor is used as the control terminal of the driving sub-module, the compensation sub-module includes a compensation capacitor and a compensation transistor, the gate electrode of the driving transistor is electrically coupled to a first electrode of the compensation capacitor, and a second electrode of the compensation capacitor is electrically coupled to the high level signal terminal;

the gate electrode of the compensation transistor is electrically coupled to the first data input control terminal, a first electrode of the compensation transistor is electrically coupled to the gate electrode of the driving transistor, and a second electrode of the compensation transistor is electrically coupled to a second electrode of the driving transistor.

In some implementations, the pixel circuit further includes a reset module, an input terminal of the reset module is electrically coupled to an initial level signal terminal, an output terminal of the reset module is electrically coupled to the control terminal of the driving sub-module, and the input terminal of the reset module and the output terminal of the reset module are capable of being electrically coupled with each other or decoupled from each other under the control of a signal received by the control terminal of the reset module.

In some implementations, the data writing sub-module includes a data writing transistor, a first electrode of the data writing transistor is formed as the first data input terminal, a second electrode of the data writing transistor is electrically coupled to the driving sub-module, and a gate electrode of the data writing transistor is formed as the first data input control terminal.

In some implementations, the driving sub-module includes a driving transistor, a gate electrode of the driving transistor is used as the control terminal of the driving sub-module, and the light emitting control sub-module includes a first light emitting control sub-module and a second light emitting control sub-module;

the first light emitting control sub-module includes a first light emitting control transistor, a gate electrode of the first light emitting control transistor is formed as the light emitting control terminal, a first electrode of the first light emitting control transistor is electrically coupled to the high level signal terminal, and a second electrode of the first light emitting control transistor is electrically coupled to a first electrode of the driving transistor;

the second light emitting control sub-module includes a second light emitting control transistor, a gate electrode of the second light emitting control transistor is electrically coupled to the gate electrode of the first light emitting control transistor, a first electrode of the second light emitting control transistor is electrically coupled to the a second electrode of the driving transistor, and a second electrode of the second light emitting control transistor is electrically coupled to an input terminal of the light emitting module;

the second light emitting control transistor is of the same type as the first light emitting control transistor.

In some implementations, the fingerprint identification module includes a fingerprint identification reference capacitor, an identification output transistor, a signal reset transistor, an amplifying transistor and a detection electrode, a first electrode of the fingerprint identification reference capacitor is electrically coupled to the high level signal terminal, and a second electrode of the fingerprint identification reference capacitor is electrically coupled to a first electrode of the signal reset transistor and a gate electrode of the amplifying transistor;

a first electrode of the amplifying transistor is electrically coupled to a first electrode of the identification output transistor, and a second electrode of the amplifying transistor is electrically coupled to a reference level signal terminal;

a gate electrode of the signal reset transistor is formed as the identification driving control terminal, the first electrode of the signal reset transistor is electrically coupled to the gate electrode of the amplifying transistor, and a second electrode of the signal reset transistor is electrically coupled to the reference level signal terminal;

a gate electrode of the identification output transistor is electrically coupled to the light emitting control terminal, and a second electrode of the identification output transistor is formed as the identification signal output terminal;

the detection electrode is electrically coupled to the second electrode of the fingerprint identification reference capacitor.

In some implementations, the light emitting module includes a light emitting element, a first light emitting auxiliary transistor, a second light emitting auxiliary transistor, and a light emitting auxiliary capacitor;

a gate electrode of the first light emitting auxiliary transistor is electrically coupled to a first electrode of the light emitting auxiliary capacitor, a first electrode of the first light emitting auxiliary transistor is formed as the input terminal of the light emitting module, and a second electrode of the first light emitting auxiliary transistor is electrically coupled to the light emitting element;

a gate electrode of the second light emitting auxiliary transistor is electrically coupled to a second data input control terminal, a first electrode of the second light emitting auxiliary transistor is electrically coupled to the first electrode of the light emitting auxiliary capacitor, a second electrode of the second light emitting auxiliary transistor is electrically coupled to a second data input terminal, and a second electrode of the light emitting auxiliary capacitor is electrically coupled to the reference level signal terminal.

As a second aspect of the present disclosure, there is provided a driving method of a pixel circuit, where the pixel circuit is the above pixel circuit provided by the present disclosure, the driving method includes a plurality of driving periods, and in each driving period, the driving method includes a main light emitting stage including:

in a sub-stage of data writing and resetting the fingerprint identification module, providing an effective signal to the first data input control terminal, writing a data voltage into the light emitting driving module through the first data input terminal, and resetting the fingerprint identification module;

in a sub-stage of light emitting and fingerprint identification, providing an effective signal to the light emitting control terminal, so that the light emitting driving module is electrically coupled to the light emitting module, and the identification signal output terminal is capable of outputting a signal.

In some implementations, each driving period further includes at least one auxiliary light emitting stage after the main light emitting stage,

the main light emitting stage further includes:

in a sub-stage of display duty enable input and fingerprint collection between the sub-stage of data writing and resetting the fingerprint identification module and the sub-stage of light emitting and fingerprint identification, providing an effective control signal to the gate electrode of the second light emitting auxiliary transistor and providing an effective data signal to the second electrode of the second light emitting auxiliary transistor through the second data input terminal, so as to write the data signal input through the second data input terminal into the light emitting auxiliary capacitor,

the auxiliary light emitting stage includes:

in a first auxiliary light emitting sub-stage, providing an effective control signal to the gate electrode of the second light emitting auxiliary transistor through the second data input control terminal, and providing an effective data signal to the second electrode of the second light emitting auxiliary transistor through the second data input terminal, so as to write the data signal input through the second data input terminal into the light emitting auxiliary capacitor;

in a second auxiliary light emitting sub-stage, providing an effective light emitting control signal to the light emitting control terminal so as to control the light emitting element to be electrically coupled to the driving sub-module.

As a third aspect of the present disclosure, there is provided a display panel, including a plurality of pixel units, each pixel unit is provided with a pixel circuit, where the pixel circuit in at least one of the pixel units is the above-mentioned pixel circuit provided by the present disclosure.

In some implementations, the pixel units are arranged in rows and columns,

each pixel unit in an odd-numbered row is provided with the pixel circuit provided by the present disclosure; or alternatively,

each pixel unit in an even-numbered row is provided with the pixel circuit provided by the present disclosure.

In some implementations, the pixel units are arranged in rows and columns, and in any row, pixel circuits, each of which is provided by the present disclosure, are arranged at intervals of a predetermined number of pixel units.

In some implementations, the display panel includes a plurality of fingerprint identification detection lines, where the pixel units including the pixel circuits, each of which is provided by the present disclosure, are arranged in a matrix,

multiple columns of pixel units including the pixel circuits, each of which is provided by the present disclosure, correspond to the fingerprint identification detection lines one by one, and identification signal output terminals of the pixel circuits in a same column of pixel units are electrically coupled to a same corresponding one of the fingerprint identification detection lines.

As a fourth aspect of the present disclosure, there is provided a pixel circuit including a data writing transistor, a driving transistor, a compensation capacitor, a compensation transistor, a reset transistor, a first light emitting control transistor, a second light emitting control transistor, a light emitting diode, a first light emitting auxiliary transistor, a second light emitting auxiliary transistor, a light emitting auxiliary capacitor, a fingerprint identification reference capacitor, an identification output transistor, a signal reset transistor, an amplifying transistor, and a detection electrode,

a first electrode of the data writing transistor is electrically coupled to a first data input terminal, a second electrode of the data writing transistor is electrically coupled to a first electrode of the driving transistor, a gate electrode of the data writing transistor is electrically coupled to a first data input control terminal,

a gate electrode of the driving transistor is electrically coupled to a first electrode of the compensation capacitor, a second electrode of the compensation capacitor is electrically coupled to a high level signal terminal, a gate electrode of the compensation transistor is electrically coupled to the first data input control terminal, a first electrode of the compensation transistor is electrically coupled to the gate electrode of the driving transistor, and a second electrode of the compensation transistor is electrically coupled to a second electrode of the driving transistor,

a first electrode of the reset transistor is electrically coupled to an initial level signal terminal, a second electrode of the reset transistor is electrically coupled to the gate electrode of the driving transistor, a gate electrode of the reset transistor is electrically coupled to a reset signal terminal,

a gate electrode of the first light emitting control transistor is electrically coupled to a light emitting control terminal, a first electrode of the first light emitting transistor is electrically coupled to the high level signal terminal, a second electrode of the first light emitting control transistor is electrically coupled to the first electrode of the driving transistor,

a gate electrode of the second light emitting control transistor is electrically coupled to the gate electrode of the first light emitting control transistor, a first electrode of the second light emitting control transistor is connected to the second electrode of the driving transistor, a second electrode of the second light emitting control transistor is electrically coupled to a first electrode of the first light emitting auxiliary transistor,

a gate electrode of the first light emitting auxiliary transistor is electrically coupled to a first electrode of the light emitting auxiliary capacitor, a second electrode of the first light emitting auxiliary transistor is electrically coupled to an anode of the light emitting diode,

a gate electrode of the second light emitting auxiliary transistor is electrically coupled to a second data input control terminal, a first electrode of the second light emitting auxiliary transistor is electrically coupled to the first electrode of the light emitting auxiliary capacitor, a second electrode of the second light emitting auxiliary transistor is electrically coupled to a second data input terminal, and a second electrode of the light emitting auxiliary capacitor is electrically coupled to a reference level signal terminal,

a cathode of the light emitting diode is grounded,

a first electrode of the fingerprint identification reference capacitor is electrically coupled to the high level signal terminal, a second electrode of the fingerprint identification reference capacitor is electrically coupled to a first electrode of the signal reset transistor and a gate electrode of the amplifying transistor,

a first electrode of the amplifying transistor is electrically coupled to a first electrode of the identification output transistor, a second electrode of the amplifying transistor is electrically coupled to the reference level signal terminal,

a gate electrode of the signal reset transistor is electrically coupled to the first data input control terminal, and a second electrode of the signal reset transistor is electrically coupled to the reference level signal terminal;

a gate electrode of the identification output transistor is electrically coupled to the light emitting control terminal, and a second electrode of the identification output transistor is electrically coupled to the fingerprint identification detection line;

the detection electrode is electrically coupled to the second electrode of the fingerprint identification reference capacitor.

### DESCRIPTION OF DRAWINGS

The accompanying drawings, which are included to provide a further understanding of the present disclosure and constitute a part of the specification, serve to explain the present disclosure together with embodiments and implementations below, but are not intended to limit the present disclosure. In the drawings:

FIG. 1 is a schematic block diagram of a pixel circuit provided by the present disclosure;

FIG. 2 is a schematic circuit diagram of a pixel circuit provided by the present disclosure;

FIG. 3 is a schematic diagram of distribution of pixel circuits provided by the present disclosure in a display panel;

FIG. 4 is a signal timing diagram of a pixel circuit provided by the present disclosure in operation;

FIG. 5 is a schematic diagram of a pixel circuit provided by the present disclosure during a sub-stage of resetting a light emitting module;

FIG. 6 is a schematic diagram of a pixel circuit provided by the present disclosure during a sub-stage of data writing and resetting the fingerprint identification module;

FIG. 7 is a schematic diagram of a pixel circuit provided by the present disclosure during writing an auxiliary data signal;

FIG. 8 is a schematic diagram of a pixel circuit provided by the present disclosure during a sub-stage of light emitting and fingerprint identification;

FIG. 9 is a principle diagram of operation of a fingerprint identification module when identifying a valley in a fingerprint;

FIG. 10 is a principle diagram of operation of a fingerprint identification module when identifying a ridge in a fingerprint.

### DESCRIPTION OF EMBODIMENTS

Specific embodiments and implementations of the present disclosure are described in detail below with reference to the accompanying drawings. It should be understood that the specific embodiments and implementations described herein are merely used to illustrate and explain, but not to limit, the present disclosure.

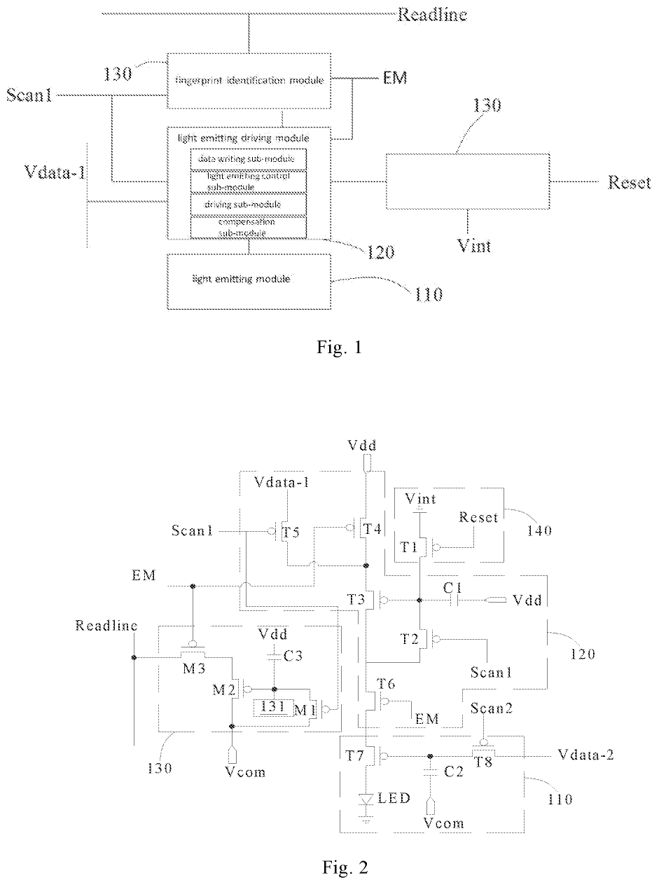

As an aspect of the present disclosure, there is provided a pixel circuit, and as shown in FIG. 1, the pixel circuit includes a light emitting module 110, a light emitting driving module 120, and a fingerprint identification module 130, where the light emitting driving module 120 is configured to drive the light emitting module 110 to emit light, and the fingerprint identification module 130 is configured to perform fingerprint identification.

As shown in FIG. 1, the light emitting driving module 120 includes a first data input terminal Vdata-1, a first data input control terminal Scan1 and a light emitting control terminal EM, and the light emitting driving module 120 is configured to output a driving signal to the light emitting module 110 under the control of signals received by the first data input terminal Vdata-1, the first data input control terminal Scan1 and the light emitting control terminal EM. In addition, the light emitting driving module 120 further includes a high level signal terminal (e.g., providing a high level voltage Vdd).

The fingerprint identification module 130 includes an identification signal output terminal, an identification signal output control terminal, and an identification driving control terminal. The identification signal output control terminal is electrically coupled to the light emitting control terminal EM, the identification driving control terminal is electrically coupled to the first data input control terminal Scan1, the identification signal output terminal of the fingerprint identification module 130 is configured to output an identification signal under the control of signals received by the identification driving control terminal and the identification signal output control terminal, and the identification signal output by the fingerprint identification module 130 is influenced by a fingerprint identified by the fingerprint identification module 130.

It should be noted that “the identification signal output by the fingerprint identification module 130 being influenced by a fingerprint identified by the fingerprint identification module 130” means that the fingerprint identification module 130 can output different identification signals according to different states of the fingerprint, in other words, the fingerprint identification module 130 has a function of identifying the fingerprint.

In the pixel circuit provided by the present disclosure, the identification signal output control terminal of the fingerprint identification module 130 is electrically coupled to the light emitting control terminal EM of the light emitting driving module 120, and the identification driving control terminal of the fingerprint identification module 130 is electrically coupled to the first data input control terminal Scan1 of the light emitting driving module 120, that is, the fingerprint identification module 130 and the light emitting driving module 120 share a control terminal, so that the pixel circuit has both the light emitting function and the fingerprint identification function, and the light emitting function and the fingerprint identification function are efficiently integrated. A display panel including the pixel circuit provided by the present disclosure has both the light emitting function and the fingerprint identification function, so that no fingerprint identification panel is required to be arranged on a light exiting surface of the display panel, and a whole thickness of the display panel with the fingerprint identification function can be reduced.

In the pixel circuit provided by the present disclosure, the identification driving control terminal of the fingerprint identification module 130 is electrically coupled to the first data input control terminal Scan1, so that the fingerprint identification module 130 can collect fingerprint information when the light emitting driving module 120 writes a data signal, and the identification signal output control terminal of the fingerprint identification module 130 and the light emitting control terminal EM are integrated as a piece (i.e., electrically coupled to each other), so that the fingerprint identification module 130 can output a signal through the identification signal output terminal when the light emitting module 110 emits light. Therefore, with the pixel circuit provided by the present disclosure, the number and types of control signals required for realizing light emitting control and fingerprint identification can be reduced, resulting in a simple driving method, and further resulting in a simple structure of a driving module for driving the pixel circuit and a reduced cost.

In the pixel circuit provided in the present disclosure, a specific type of the light emitting module 110 is not particularly limited. For example, the light emitting module 110 may include an organic light emitting diode LED as a light emitting element. In order to avoid non-uniform light emitting of different pixel units in the display panel caused by threshold voltage shift of a driving transistor for driving the organic light emitting diode to emit light, the light emitting driving module 120 may optionally have a function of compensating a threshold voltage of the driving transistor.

In some implementations, the light emitting driving module 120 includes a data writing sub-module 121, a light emitting control sub-module 122, a driving sub-module 123, and a compensation sub-module 124.

A control terminal of the data writing sub-module 121 is electrically coupled to the first data input control terminal Scan1, an output terminal of the data writing sub-module 121 is electrically coupled to the driving sub-module 123, an input terminal of the data writing sub-module 121 is electrically coupled to the first data input terminal Vdata-1, and the input terminal and the output terminal of the data writing sub-module 121 are capable of being electrically coupled with each other in response to that the first data input control terminal Scan1 receives an effective scanning signal.

The light emitting control sub-module 122 may be electrically coupled between the driving sub-module 123 and a high level signal terminal, and/or the light emitting control sub-module 122 may be electrically coupled between the driving sub-module 123 and the light emitting module 110, and a control terminal of the driving sub-module 123 may be electrically coupled to the compensation sub-module 120.

The compensation sub-module 124 is electrically coupled to the high level signal terminal and the driving sub-module 123, and a control terminal of the compensation sub-module 124 is further electrically coupled to the first data input control terminal Scan 1. The compensation sub-module 124 is capable of storing a data voltage input through the data writing sub-module 121 under the control of a signal received by the control terminal of the compensation sub-module 124.

It should be noted that, when the first data input control terminal Scan1 provides an effective signal, the compensation sub-module 124 stores the data voltage input through the data writing sub-module 121.

In some implementations, as shown in FIG. 2, the driving sub-module 123 may include a driving transistor T3, and with the compensation sub-module 124, a gate-source voltage of the driving transistor T3 may be calculated by using the following formula (1) and a saturation driving current of the driving transistor T3 may be calculated by using the following formula (2).

Vgs=Vdd+Vth−Vdata (1)

I=K*(Vgs−Vth)²=K*[Vdd+Vth−Vdata−Vth]²=K*(Vdd−Vdata)² (2)

where Vgs is the gate-source voltage of the driving transistor T3;

Vdata is the data voltage;

Vth is a threshold voltage of the driving transistor T3;

I is the driving current output by the driving transistor T3;

K is a constant relating to a size of the driving transistor T3;

Vdd is a high level voltage provided by the high level signal terminal.

As can be seen from the formula (2), the driving current of the driving transistor T3 is independent of the threshold voltage of the driving transistor T3.

In the pixel circuit provided by the present disclosure, a specific structure of the compensation sub-module 124 is not specifically limited, for example, the compensation sub-module 124 may include a compensation capacitor C1 and a compensation transistor T2.

As shown in FIG. 2, a gate electrode of the driving transistor T3 may be electrically coupled to a first electrode of the compensation capacitor C1, a second electrode of the compensation capacitor C1 may be electrically coupled to the high level signal terminal, a gate electrode of the compensation transistor T2 may be electrically coupled to the first data input control terminal Scan1, a first electrode of the compensation transistor T2 may be electrically coupled to the gate electrode of the driving transistor T3, and a second electrode of the compensation transistor T2 may be electrically coupled to a second electrode of the driving transistor T3.

When the first data input control terminal Scan1 inputs an effective scanning signal, the first electrode of the compensation transistor T2 and the second electrode of the compensation transistor T2 are electrically coupled, so that the driving transistor T3 forms a diode. Meanwhile, the input terminal of the data writing sub-module 121 is electrically coupled to the output terminal of the data writing sub-module 121, so that the data voltage Vdata input through the first data input terminal Vdata-1 and the threshold voltage Vth of the driving transistor T3 can be stored in the compensation capacitor C1.

When the pixel circuit provided by the present disclosure is applied to a display panel, in order to ensure that the pixel circuit can normally emit light and can realize normal fingerprint identification when the display panel displays different frames of image, in some implementations, the pixel circuit may further include a reset module 140, an input terminal of the reset module 140 may be electrically coupled to an initial level signal terminal Vint, and an output terminal of the reset module 140 may be electrically coupled to the control terminal (for example, the gate electrode of the driving transistor T3) of the driving sub-module 123. With the reset module 140, the gate electrode of the driving transistor T3 can be reset after the display panel finishes displaying a frame of image or before the display panel begins displaying a frame of image, so as to ensure that the light emitting element in the light emitting module 110 do not emit light in a non-light emitting period.

In some implementations, as shown in FIG. 2, the reset module 140 may include a reset transistor T1. A gate electrode of the reset transistor T1 may be electrically coupled to a reset signal terminal Reset, a first electrode of the reset transistor T1 may be electrically coupled to the initial level signal terminal Vint, a second electrode of the reset transistor Ti may be electrically coupled to the gate electrode of the driving transistor T3, and when the gate electrode of the reset transistor T1 receives an effective reset signal, the first electrode and the second electrode of the reset transistor T1 are electrically coupled with each other, so that a gate voltage of the driving transistor T3 can be reset to an initial voltage, and the light emitting element in the light emitting module 110 can be ensured to be in a non-light emitting state in the reset sub-stage.

In the pixel circuit provided by the present disclosure, a specific structure of the data writing sub-module 121 is not limited in particular, and in some implementations, as shown in FIG. 2, the data writing sub-module 121 may include a data writing transistor T5, a first electrode of the data writing transistor T5 is formed as the first data input terminal Vdata-1, a second electrode of the data writing transistor T5 is electrically coupled to a first electrode of the driving transistor T3, and a gate electrode of the data writing transistor T5 is formed as the first data input control terminal Scan 1.

When it is required to write the data voltage to the gate electrode of the driving transistor T3, an effective scanning signal is provided to the first data input control terminal Scan1, and the first electrode and the second electrode of the data writing transistor T5 are electrically coupled with each other, so that the data voltage input through the first data input terminal Vdata-1 is written to the gate electrode of the driving transistor T3.

In order to ensure that the light emitting module 110 is driven to emit light only in the light emitting stage, in some implementations, the light emitting control sub-module 122 may include a first light emitting control sub-module 111 and a second light emitting control sub-module 112.

As shown in FIG. 2, the first light emitting control sub-module 111 may include a first light emitting control transistor T4, a gate electrode of the first light emitting control transistor T4 is formed as the light emitting control terminal EM, a first electrode of the first light emitting control transistor T4 is electrically coupled to the high level signal terminal, and a second electrode of the first light emitting control transistor T4 is electrically coupled to the first electrode of the driving transistor T3.

As shown in FIG. 2, the second light emitting control sub-module 112 may include a second light emitting control transistor T6, a gate electrode of the second light emitting control transistor T6 is electrically coupled to the gate electrode (i.e., the light emitting control terminal EM) of the first light emitting control transistor T4, a first electrode of the second light emitting control transistor T6 is electrically coupled to the second electrode of the driving transistor T3, and a second electrode of the second light emitting control transistor T6 is electrically coupled to an input terminal of the light emitting module 110.

Since the gate electrode of the first light emitting control transistor T4 and the gate electrode of the second light emitting control transistor T6 are electrically coupled with each other, the first light emitting control transistor T4 and the second light emitting control transistor T6 may be synchronously controlled. It should be noted that the first light emitting control transistor T4 is of the same type as the second light emitting control transistor T6, that is, the first light emitting control transistor T4 and the second light emitting control transistor T6 are either both N-type transistors or both P-type transistors. In some implementations, the first light emitting control transistor T4 and the second light emitting control transistor T6 shown in FIG. 2 may be both P-type transistors.

In the pixel circuit provided by the present disclosure, a specific type of the fingerprint identification module 130 is not particularly limited, for example, the fingerprint identification module 130 may be a photosensitive type fingerprint identification module, or may be a capacitive type fingerprint identification module. In some implementations, as shown in FIG. 2, the fingerprint identification module 130 is the capacitive type fingerprint identification module. Specifically, as shown in FIG. 2, the fingerprint identification module 130 may include a fingerprint identification reference capacitor C3, an identification output transistor M3, a signal reset transistor M1, an amplifying transistor M2, and a detection electrode 131.

A first electrode of the fingerprint identification reference capacitor C3 is electrically coupled to the high level signal terminal, and a second electrode of the fingerprint identification reference capacitor C3 is electrically coupled to a first electrode of the signal reset transistor M1 and a gate electrode of the amplifying transistor M2.

A first electrode of the amplifying transistor M2 is electrically coupled to a first electrode of the identification output transistor M3, and a second electrode of the amplifying transistor M2 is electrically coupled to a reference level signal terminal Vcom.

A gate electrode of the signal reset transistor M1 is formed as the identification driving control terminal, a first electrode of the signal reset transistor M1 is electrically coupled to the gate electrode of the amplifying transistor M2, and a second electrode of the signal reset transistor M1 is electrically coupled to the reference level signal terminal Vcom.

A gate electrode of the identification output transistor M3 is electrically coupled to the light emitting control terminal EM, and a second electrode of the identification output transistor M3 is formed as the identification signal output terminal.

The detection electrode 131 is electrically coupled to a second electrode of the fingerprint identification reference capacitance C3, and the detection electrode 131 is configured to form a detection capacitance with a finger.

Note that, the amplifying transistor M2 operates in an amplification region, so that an input current can be amplified and then output.

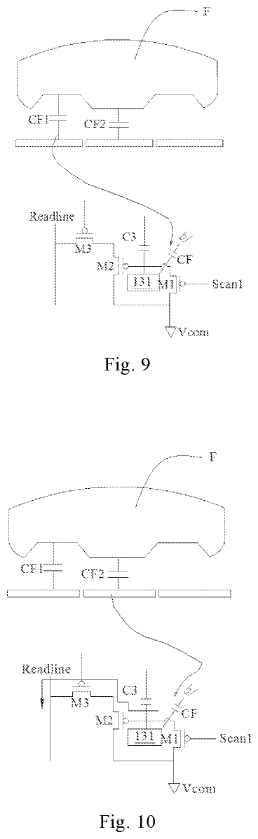

In the fingerprint identification module 130, the amplifying transistor M2 has a parasitic capacitance Ct in addition to the fingerprint identification reference capacitance C3. When a finger touches a screen of the display panel, the finger further forms a detection capacitance CF with the detection electrode 131. As shown in FIG. 9 and FIG. 10, the detection capacitance CF may be equal to a detection capacitance CF1 formed between a valley of a fingerprint and the detection electrode 131 or a detection capacitance CF2 formed between a ridge of the fingerprint and the detection electrode 131. A difference in the detection capacitance CF causes a difference in a gate potential of the amplifying transistor M2 (a magnitude of the gate potential of the amplifying transistor M2 is determined by respective ratios of the fingerprint identification reference capacitance C3, the parasitic capacitance Ct of the amplifying transistor M2, and the detection capacitance CF). In general, the larger the detection capacitance CF, the smaller the gate potential of the amplifying transistor M2, whereas the smaller the detection capacitance CF, the larger the gate potential of the amplifying transistor M2. Since the amplifying transistor M2 operates in an amplifying region, a variation of the gate potential of the amplifying transistor M2 causes a variation of leakage current generated by the amplifying transistor M2, and thus resulting in a variation of signal output from the identification signal output terminal of the fingerprint identification module 130 to a fingerprint identification detection line Readline. Therefore, an appearance of the fingerprint can be determined according to a signal of the fingerprint identification detection line Readline.

FIG. 9 is a principle diagram of operation of the fingerprint identification module 130 when identifying a valley of the fingerprint, and FIG. 10 is a principle diagram of operation of the fingerprint identification module 130 when identifying a ridge of the fingerprint.

Specifically, as shown in FIG. 9, the detection capacitance CF is equal to CF1, and is relatively small, and accordingly, the gate potential of the amplifying transistor M2 is relatively high. In some implementations, the amplifying transistor M2 is a P-type transistor, and when the gate potential of the amplifying transistor M2 is relative high, the amplifying transistor M2 is turned off, and accordingly, the fingerprint identification detection line Readline detects an initial current signal, and the pixel circuit identifies the valley of the fingerprint.

As shown in FIG. 10, the detection capacitance CF is equal to CF2, and is relatively large, and accordingly, the gate potential of the amplifying transistor M2 is relatively low. In some implementations, the amplifying transistor M2 is a P-type transistor, and when the gate potential of the amplifying transistor M2 is relatively low, the amplifying transistor M2 is turned on, and accordingly, the fingerprint identification detection line Readline detects an amplified signal, and the pixel circuit identifies the ridge of the fingerprint.

In the pixel circuit provided by the present disclosure, a specific structure of the light emitting module 110 is not particularly limited. In some implementations, as shown in FIG. 2, the light emitting module 110 includes a first light emitting auxiliary transistor T7, a second light emitting auxiliary transistor T8, and a light emitting auxiliary capacitor C2 in addition to the organic light emitting diode LED serving as the light emitting element.

A gate electrode of the first light emitting auxiliary transistor T7 is electrically coupled to a first electrode of the light emitting auxiliary capacitor C2, a first electrode of the first light emitting auxiliary transistor T7 is formed as the input terminal of the light emitting module 110, and a second electrode of the first light emitting auxiliary transistor T7 is electrically coupled to an anode of the light emitting element (i.e., the light emitting diode LED in the drawing).

A gate electrode of the second light emitting auxiliary transistor T8 is formed as a control terminal Scan2 of the light emitting module 110, a first electrode of the second light emitting auxiliary transistor T8 is electrically coupled to the first electrode of the light emitting auxiliary capacitor C2, a second electrode of the second light emitting auxiliary transistor T8 is electrically coupled to a second data input terminal Vdata-2, and a second electrode of the light emitting auxiliary capacitor C2 is electrically coupled to the reference level signal terminal Vcom.

It should be note that, after the light emitting auxiliary capacitor C2, the first light emitting auxiliary transistor T7, and the second light emitting auxiliary transistor T8 are provided, a light emitting duration of the light emitting element can be strictly controlled.

As a second aspect of the present disclosure, there is provided a driving method of a pixel circuit, where the pixel circuit is the above pixel circuit provided by the present disclosure, the driving method includes a plurality of driving periods, as shown in FIG. 4, in each driving period, the driving method includes a main light emitting stage P1, and the main light emitting stage P1 includes the following steps performed in sequence:

in a sub-stage t2 of data writing and resetting the fingerprint identification module, providing an effective signal to the first data input control terminal Scan1, so as to write a data voltage into the light emitting driving module 120 through the first data input terminal Vdata-1 and reset the fingerprint identification module 130;

in a sub-stage t4 of light emitting and fingerprint identification, providing an effective signal to the light emitting control terminal EM, so that the light emitting driving module 120 and the light emitting module 110 are electrically coupled with each other, and the identification signal output terminal can output an identification signal.

In the pixel circuit provided by the present disclosure, the first data input control terminal Scan1 can control both data voltage writing through the first data input terminal Vdata-1 and resetting of the fingerprint identification module, so that the driving method is simplified. By resetting the fingerprint identification module, accurate fingerprint information can be output in each period.

The light emitting control terminal EM can control light emitting timing of the light emitting module 110 and output timing of the fingerprint identification module 130, in other words, when the light emitting module 110 emits light, the fingerprint identification module 130 outputs the identification signal carrying fingerprint information, thereby simplifying the driving method.

When the pixel circuit includes a reset module 140, the main light emitting stage P1 further includes the following steps performed before the sub-stage t2 of data writing and resetting the fingerprinting module:

in a sub-stage t1 of resetting the light emitting module, providing an effective reset signal to the control terminal (i.e., the reset signal terminal Reset) of the reset module 140 to reset the control terminal (i.e., the gate electrode of the driving transistor T3) of the driving sub-module 123.

For the organic light emitting diode as the light emitting element, a brightness of the organic light emitting diode is relating not only to the driving current but also to the light emitting duration. In order to realize a multi-gray scale display with a simple driving method, in some implementations, when the light emitting module 110 of the pixel circuit includes the first light emitting auxiliary transistor T7, the second light emitting auxiliary transistor T8 and the light emitting auxiliary capacitor C2, each driving period further includes at least one auxiliary light emitting stage performed after the main light emitting stage P1, and the main light emitting stage P1 further includes the following steps performed between the sub-stage t2 of data writing and resetting the fingerprint identification module and the sub-stage t4 of light emitting and fingerprint identification:

in a sub-stage t3 of display duty enable input and fingerprint collection, providing an effective control signal to the gate electrode of the second light emitting auxiliary transistor T8 through the second data input control terminal Scan2, and providing an effective data signal to the first electrode of the second light emitting auxiliary transistor T2 through the second data input terminal Vdata-2, so as to write the data signal input by the second data input terminal Vdata-2 into the light emitting auxiliary capacitor C2.

The auxiliary light emitting stage includes the following steps performed in sequence:

in a first auxiliary light emitting sub-stage tl', providing an effective control signal to the gate electrode of the second light emitting auxiliary transistor T8 through the second data input control terminal Scan2, and providing an effective data signal to the first electrode of the second light emitting auxiliary transistor T8 through the second data input terminal Vdata-2, so as to write the data signal input from the second data input terminal Vdata-2 into the light emitting auxiliary capacitor C2;

in a second auxiliary light emitting sub-stage t2′, providing an effective light emitting control signal to the light emitting control terminal EM to control the anode of the light emitting diode to be electrically coupled to the second electrode of the driving transistor T3;

in a third auxiliary light emitting sub-stage t3′, providing an ineffective signal to the light emitting control terminal EM and the gate electrode of the second light emitting auxiliary transistor T8.

In the first auxiliary light emitting sub-stage tl', an effective signal may be provided to the second data input control terminal Scan2 to control the second light emitting auxiliary transistor T8 to be turned on, and at this time, a signal is input through the second data input terminal Vdata-2 to be stored in the light emitting auxiliary capacitor C2.

In the second auxiliary light emitting sub-stage t2′, an electric signal stored in the light emitting auxiliary capacitor C2 can ensure that the first light emitting auxiliary transistor T7 is turned on, and at the same time, the second light emitting control transistor T6 can be ensured to be turned on by the effective light emitting control signal input from the light emitting control terminal EM. A duration of the first auxiliary light emitting transistor T7 being turned on can be determined according to an amount of electricity stored in the auxiliary light emitting capacitor C2, and the light emitting duration of the light emitting diode in the auxiliary light emitting stage can be controlled, thereby controlling a gray scale displayed by the pixel circuit.

In the third auxiliary light emitting sub-stage t3′, the light emitting diode does not emit light.

In the driving method, it is only necessary to compensate the threshold voltage of the driving transistor T3 in the main light emitting stage P1, and the threshold voltage of the driving transistor T3 is still compensated in the auxiliary light emitting stage.

In the driving method of the pixel circuit provided by the present disclosure, display with different gray scales can be realized by controlling the light emitting duration of the light emitting diode in the auxiliary light emitting stage, that is, the multi-gray scale display can be realized in one driving period of the driving method, and the method is simple and easy to be realized.

In some implementations, as shown in FIG. 4, one driving period may include two auxiliary light emitting stages, i.e., an auxiliary light emitting stage P2 and an auxiliary light emitting stage P3, in which durations of effective light emitting control signals are different, so that a light emitting brightness of the light emitting diode in the auxiliary light emitting stage P2 is different from a light emitting brightness of the light emitting diode in the auxiliary light emitting stage P3.

The principle of operation of the specific pixel circuit provided in FIG. 2 is explained below in conjunction with FIG. 2 to FIG. 8.

In some implementations, thin film transistors involved in the pixel circuit shown in FIG. 2 may all be P-type transistors.

The light emitting module 110 includes the light emitting diode LED, the first light emitting auxiliary transistor T7, the second light emitting auxiliary transistor T8, and the light emitting auxiliary capacitor C2.

The light emitting driving module 120 includes the first data input terminal Vdata-1, the first data input control terminal Scan1, the light emitting control terminal EM, the driving transistor T3, the data writing transistor T5, the first light emitting control transistor T4, and the second light emitting control transistor T6.

The fingerprint identification module 130 includes the fingerprint identification reference capacitor C3, the identification output transistor M3, the signal reset transistor Ml, the amplifying transistor M2 and the detection electrode 131.

The reset module 140 includes the reset transistor T1.

As shown in FIG. 4, one driving period includes three light emitting stages, i.e., the main light emitting stage P1, the auxiliary light emitting stage P2, and the auxiliary light emitting stage P3.

The light emitting stage P1 includes the sub-stage t1 of resetting the light emitting module, the sub-stage t2 of data writing and resetting the fingerprint identification module, the sub-stage t3 of display duty enable input and fingerprint collection, and the sub-stage t4 of light emitting and fingerprint identification.

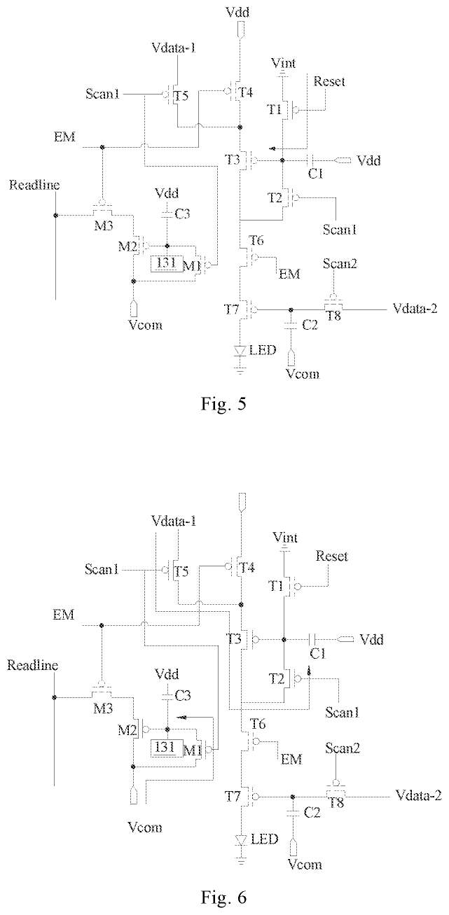

FIG. 5 is a schematic diagram showing states of the thin film transistors in the pixel circuit during the sub-stage tl of resetting the light emitting module. It should be note that, the thin film transistor shown by a dotted line is in an off state (i.e., turned off), and the thin film transistor shown by a solid line is in an on state (i.e., turned on). As shown in FIG. 4, in the reset sub-stage t1, only a signal received by the reset signal terminal Reset is a low level signal, and thus, as shown in FIG. 5, only the reset transistor T1 is turned on, so that the gate electrode of the driving transistor T3 and the first electrode of the compensation capacitor C1 can be reset. The solid arrow indicates a direction of current.

FIG. 6 is a schematic diagram showing states of the thin film transistors in the pixel circuit during the sub-stage t2 of data writing and resetting fingerprint identification module. As shown in FIG. 4, in the sub-stage t2 of data writing and resetting the fingerprint identification module, only the first data input control terminal Scan1 receives an effective low level signal. Since the gate electrode of the signal reset transistor M1 of the fingerprint identification module 130 is electrically coupled to the first data input control terminal Scan1, and the data writing transistor T5 is electrically coupled to the first data input control terminal Scan1, the signal reset transistor M1 is turned on, the amplifying transistor M2 is turned on, the data writing transistor T5 is turned on, the driving transistor T3 is turned on, and the compensation transistor T2 is turned on, so that the threshold voltage of the driving transistor T3 and the data voltage written through the first data input terminal Vdata-1 can be stored in the compensation capacitor C1.

In the sub-stage t3 of display duty enable input and fingerprint collection, as shown in FIG. 9 and FIG. 10, the detection capacitance CF is equal to the detection capacitance CF1 formed between the valley of the fingerprint and the detection electrode 131 or the detection capacitance CF2 formed between the ridge of the fingerprint and the detection electrode 131. The difference in the detection capacitance CF causes the difference in the gate potential of the amplifying transistor M2 (the magnitude of the gate potential of the amplifying transistor M2 is determined by the respective ratios of the fingerprint identification reference capacitance C3, the parasitic capacitance Ct of the amplifying transistor M2, and the detection capacitance CF). In general, the larger the detection capacitance CF, the smaller the gate potential of the amplifying transistor M2, whereas the smaller the detection capacitance CF, the larger the gate potential of the amplifying transistor M2. Since the amplifying transistor M2 operates in the amplifying region, the variation of the gate potential of the amplifying transistor M2 causes the variation of the leakage current generated by the amplifying transistor M2, and thus resulting in the variation of the signal output from the identification signal output terminal of the fingerprint identification module 130 to the fingerprint identification detection line Readline. The appearance of the fingerprint can be determined according to the signal of the fingerprint identification detection line Readline.

FIG. 9 is a principle diagram of operation of the fingerprint identification module 130 when identifying the valley of the fingerprint, and FIG. 10 is a principle diagram of operation of the fingerprint identification module 130 when identifying the ridge of the fingerprint.

Specifically, as shown in FIG. 9, the detection capacitance CF is equal to CF1, and is relatively small, and accordingly, the gate potential of the amplifying transistor M2 is relatively high. In some implementations, the amplifying transistor M2 is a P-type transistor, and when the gate potential of the amplifying transistor M2 is relatively high, the amplifying transistor M2 is turned off, and accordingly, the fingerprint identification detection line Readline detects an initial current signal, and the pixel circuit identifies the valley of the fingerprint.

As shown in FIG. 10, the detection capacitance CF is equal to CF2, and is relatively large, and accordingly, the gate potential of the amplifying transistor M2 is relatively low. In some implementations, the amplifying transistor M2 is a P-type transistor, and when the gate potential of the amplifying transistor M2 is relatively low, the amplifying transistor M2 is turned on, and accordingly, the fingerprint identification detection line Readline detects an amplified signal, and the pixel circuit identifies the ridge of the fingerprint.

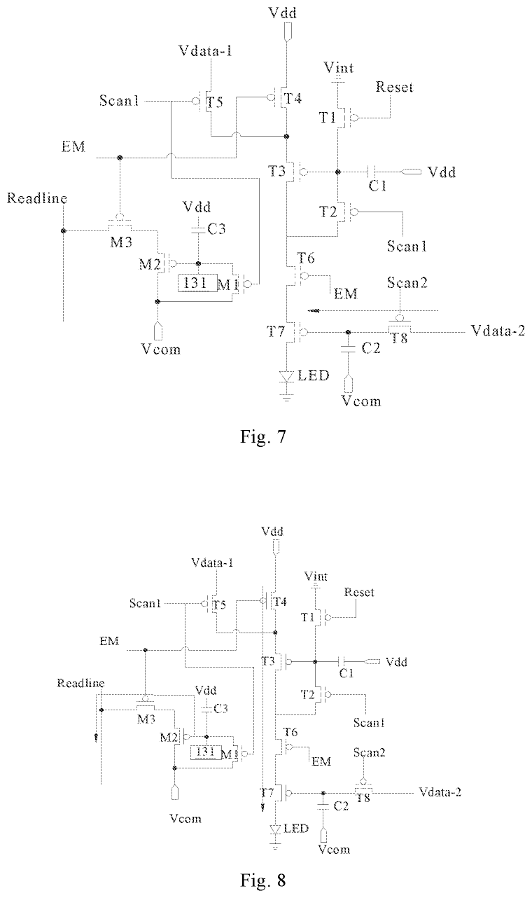

At this time, the second data input control terminal Scan2 inputs an effective low level signal, and the signal input from the second data input terminal Vdata-2 is input to the gate electrode of the first light emitting auxiliary transistor T7, where the signal input from the second data input terminal Vdata-2 has only two cases of a high level and a low level. When the second data input terminal Vdata-2 inputs a high level, the first light emitting auxiliary transistor T7 is turned off. When the second data input terminal Vdata-2 inputs a low level, the first light emitting auxiliary transistor T7 is turned on. At this time, all auxiliary data signals input from the second data input terminal Vdata-2 are stored in the light emitting auxiliary capacitor C2, as shown in FIG. 7.

In the sub-stage t4 of light emitting and fingerprint identification, the fingerprint identification module 130 is in a reading stage, the light emitting control terminal EM provides an effective signal, the identification output transistor M3 is turned on, and the identification signal output terminal of the fingerprint identification module 130 outputs a voltage signal (i.e., an identification signal) carrying fingerprint information to the fingerprint identification detection line Readline, so that the appearance of the fingerprint can be determined according to the signal of the fingerprint identification detection line Readline.

At this time, the light emitting module 110 is in a light emitting stage, the source of the driving transistor T3 receives a high level voltage Vdd provided by the high level signal terminal, and the driving current sequentially flows through the first light emitting control transistor T4, the driving transistor T3, the second light emitting control transistor T6 and the first light emitting auxiliary transistor T7, so that the light emitting diode LED emits light, as shown in FIG. 8.

In the first auxiliary light emitting sub-stage tl' of the auxiliary light emitting stage P2, an effective low level signal is provided to the second data input control terminal Scan2, so that the second auxiliary transistor T8 is turned on to write the signal input through the second data input terminal Vdata-2 into the auxiliary light emitting capacitor C2. In the second auxiliary light emitting sub-stage t2′ of the auxiliary light emitting stage P2, an effective light emitting control signal (low level signal) is provided to the light emitting control terminal EM, and both the first light emitting control transistor T4 and the second light emitting control transistor T6 are turned on. At this time, the first light emitting auxiliary transistor T7 is turned on by the electricity stored in the auxiliary light capacitor C2, and the light emitting diode OLED is driven to emit light. A brightness of the light emitting diode OLED is determined by a duration of the effective light emitting control signal. In the third auxiliary light emitting sub-stage t3′ of the auxiliary light emitting stage P2, ineffective signals, i.e., high level signals, are provided to the respective control terminals (including the first data input control terminal Scant, the second data input control terminal Scan2, the light emitting control terminal EM, and the reset signal terminal Reset), so that the light emitting diode OLED is turned off and does not emit light.

In the first auxiliary light emitting sub-stage t1′ of the auxiliary light emitting stage P3, the effective low level signal is provided to the second data input control terminal Scan2, so that the second light emitting auxiliary transistor T8 is turned on to write the signal input through the second data input terminal Vdata-2 into the auxiliary light emitting capacitor C2. In the second auxiliary light emitting sub-stage t2′ of the auxiliary light emitting stage P3, the effective light emitting control signal (low level signal) is provided to the light emitting control terminal EM, and both the first light emitting control transistor T4 and the second light emitting control transistor T6 are turned on. At this time, the first light emitting auxiliary transistor T7 is turned on by the electricity stored in the auxiliary light capacitor C2, and the light emitting diode OLED is driven to emit light. The brightness of the light emitting diode OLED is determined by the duration of the effective light emitting control signal. In the third auxiliary light emitting sub-stage t3′ of the auxiliary light emitting stage P3, the ineffective signals, i.e., high level signals, are provided to the respective control terminals (including the first data input control terminal Scan1, the second data input control terminal Scan2, the light emitting control terminal EM, and the Reset signal terminal Reset), so that the light emitting diode OLED is turned off and does not emit light.

It should be understood that the first electrode and the second electrode of each transistor in the embodiments of the present disclosure may be interchanged.

As a third aspect of the present disclosure, there is provided a display panel including a plurality of pixel units, each pixel unit is provided with a pixel circuit, where the pixel circuit in at least one of the pixel units is the above-mentioned pixel circuit provided by the present disclosure.

After integrating the fingerprint identification module in the pixel circuit, both display function and fingerprint identification function can be integrated in the display panel, there is no need to provide an out-cell fingerprint identification module outside the display panel, which can reduce a total thickness of the display panel.

In order to reduce the cost, the fingerprint identification module may be arranged in only a portion of the pixel units. Alternatively, only each pixel unit in the odd-numbered row may be provided with the pixel circuit provided by the present disclosure, and only each pixel unit in the even-numbered row may be provided with the pixel circuit provided by the present disclosure.

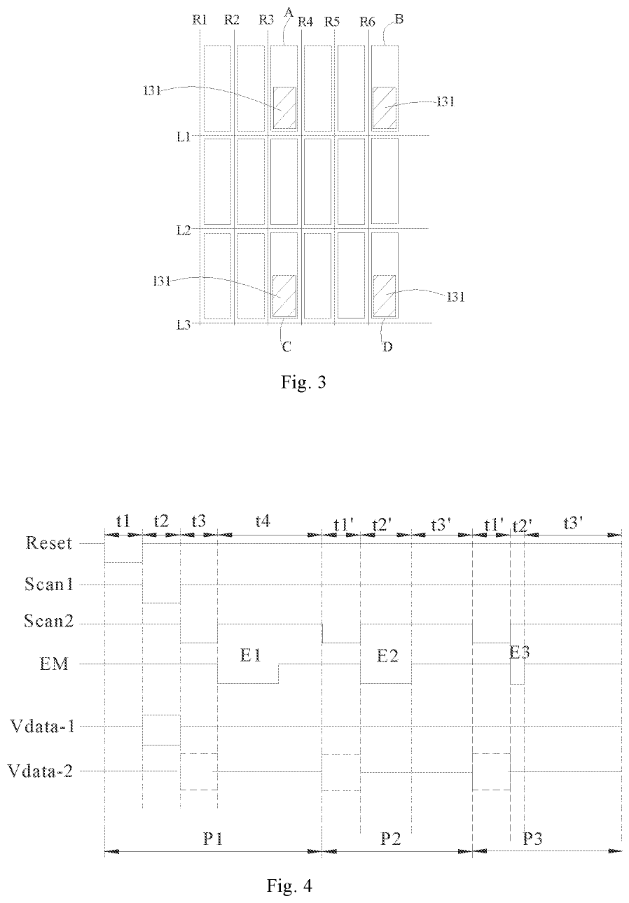

In order to further reduce the cost, it is not necessary to arrange the pixel circuit provided by the present disclosure in each column of pixel units. In some implementations, as shown in FIG. 3, in any row of pixel units provided with the pixel circuit provided by the present disclosure, a predetermined number of conventional pixel units are arranged between any two adjacent pixel units provided with the pixel circuit provided by the present disclosure. As an example, the predetermined number may be one or two, and in the implementation shown in FIG. 3, the predetermined number is two.

As shown in FIG. 3, the pixel circuit of the pixel unit A in row L1 and column R3 is the pixel circuit provided by the present disclosure, and the pixel circuit of the pixel unit B in row L 1 and column R6 is the pixel circuit provided by the present disclosure. The pixel circuit of the pixel unit C in row L3 and column R3 is the pixel circuit provided by the present disclosure, and the pixel circuit of the pixel unit D in row L3 and column R6 is the pixel circuit provided by the present disclosure.

It should be noted that, in the display panel, pixel circuits provided by the present disclosure are arranged in a matrix.

In order to facilitate signal detection, in some implementations, as shown in FIG. 2, the display panel includes a plurality of fingerprint identification detection lines Readline, a plurality of columns of pixel units including the pixel circuits provided in the present disclosure correspond to the fingerprint identification detection lines one by one, and identification signal output terminals of the pixel circuits in a same column of pixel units are electrically coupled to a same corresponding one of the fingerprint identification detection lines.

Correspondingly, the display panel may further include a fingerprint identification processing module (e.g., may be a processor) corresponding to the fingerprint identification detection lines Readline, and the fingerprint identification processing module can determine a fingerprint morphology according to signals output by the fingerprint identification detection lines Readline.

It should be understood that the above embodiments and implementations are merely exemplary embodiments and implementations that have been employed to illustrate principles of the present disclosure, however, are not to be taken as limitions to the present disclosure. It will be apparent to those skilled in the art that various changes and modifications may be made therein without departing from the spirit and scope of the present disclosure, and these changes and modifications are to be considered within the scope of the present disclosure.

1. A pixel circuit, comprising a light emitting module, a light emitting driving module and a fingerprint identification module, wherein the light emitting driving module is configured to drive the light emitting module to emit light, the fingerprint identification module is configured to perform fingerprint identification,
the light emitting driving module comprises a first data input terminal, a first data input control terminal and a light emitting control terminal, and is configured to output a driving signal to the light emitting module under the control of signals received by the first data input terminal, the first data input control terminal and the light emitting control terminal;
the fingerprint identification module comprises an identification signal output terminal, an identification signal output control terminal and an identification driving control terminal, the identification signal output control terminal is electrically coupled to the light emitting control terminal, the identification driving control terminal is electrically coupled to first data input control terminal, the identification signal output terminal of the fingerprint identification module is configured to output an identification signal under the control of signals received by the identification driving control terminal and the identification signal output control terminal, and the identification signal output by the fingerprint identification module is influenced by a fingerprint identified by the fingerprint identification module.

2. The pixel circuit according to claim 1, wherein the light emitting driving module comprises a data writing sub-module, a light emitting control sub-module, a driving sub-module, and a compensation sub-module,
a control terminal of the data writing sub-module is electrically coupled to the first data input control terminal, an output terminal of the data writing sub-module is electrically coupled to the driving sub-module, an input terminal of the data writing sub-module is electrically coupled to the first data input terminal, and the input terminal and the output terminal of the data writing sub-module are capable of being electrically coupled with each other in response to that the first data input control terminal receives an effective scanning signal;
a light emitting control sub-module is electrically coupled between the driving sub-module and a high level signal terminal, and/or the light emitting control sub-module is electrically coupled between the driving sub-module and the light emitting module, and a control terminal of the driving sub-module is electrically coupled with the compensation sub-module;
a control terminal of the compensation sub-module is electrically coupled to the first data input control terminal, the compensation sub-module is further electrically coupled to the high level signal terminal, and the compensation sub-module is capable of storing a data voltage input by the data writing sub-module under the control of a signal received by the control terminal of the compensation sub-module.

3. The pixel circuit according to claim 2, wherein the driving sub-module comprises a driving transistor, a gate electrode of the driving transistor is used as the control terminal of the driving sub-module, the compensation sub-module comprises a compensation capacitor and a compensation transistor, the gate electrode of the driving transistor is electrically coupled to a first electrode of the compensation capacitor, and a second electrode of the compensation capacitor is electrically coupled to the high level signal terminal;
a gate electrode of the compensation transistor is electrically coupled to the first data input control terminal, a first electrode of the compensation transistor is electrically coupled to the gate electrode of the driving transistor, and a second electrode of the compensation transistor is electrically coupled to a second electrode of the driving transistor.

4. The pixel circuit according to claim 2, further comprising a reset module, an input terminal of the reset module is electrically coupled to an initial level signal terminal, an output terminal of the reset module is electrically coupled to the control terminal of the driving sub-module, and the input terminal and the output terminal of the reset module are capable of being electrically coupled with each other or decoupled from each other under the control of a signal received by the control terminal of the reset module.

5. The pixel circuit according to claim 2, wherein the data writing sub-module comprises a data writing transistor, a first electrode of the data writing transistor is formed as the first data input terminal, a second electrode of the data writing transistor is electrically coupled to the driving sub-module, and a gate electrode of the data writing transistor is formed as the first data input control terminal.

6. The pixel circuit according to claim 2, wherein the driving sub-module comprises a driving transistor, a gate electrode of the driving transistor is used as the control terminal of the driving sub-module, and the light emitting control sub-module comprises a first light emitting control sub-module and a second light emitting control sub-module;
the first light emitting control sub-module comprises a first light emitting control transistor, a gate electrode of the first light emitting control transistor is formed as the light emitting control terminal, a first electrode of the first light emitting control transistor is electrically coupled to the high level signal terminal, and a second electrode of the first light emitting control transistor is electrically coupled to a first electrode of the driving transistor;
the second light emitting control sub-module comprises a second light emitting control transistor, a gate electrode of the second light emitting control transistor is electrically coupled to the gate electrode of the first light emitting control transistor, a first electrode of the second light emitting control transistor is electrically coupled to a second electrode of the driving transistor, and a second electrode of the second light emitting control transistor is electrically coupled to an input terminal of the light emitting module;
the second light emitting control transistor is of the same type as the first light emitting control transistor.

7. The pixel circuit according to claim 1, wherein the fingerprint identification module comprises a fingerprint identification reference capacitor, an identification output transistor, a signal reset transistor, an amplifying transistor, and a detection electrode,
a first electrode of the fingerprint identification reference capacitor is electrically coupled to the high level signal terminal, and a second electrode of the fingerprint identification reference capacitor is electrically coupled to a first electrode of the signal reset transistor and a gate electrode of the amplifying transistor;
a first electrode of the amplifying transistor is electrically coupled to a first electrode of the identification output transistor, and a second electrode of the amplifying transistor is electrically coupled to a reference level signal terminal;
a gate electrode of the signal reset transistor is formed as the identification driving control terminal, the first electrode of the signal reset transistor is electrically coupled to the gate electrode of the amplifying transistor, and a second electrode of the signal reset transistor is electrically coupled to the reference level signal terminal;
a gate electrode of the identification output transistor is electrically coupled to the light emitting control terminal, and a second electrode of the identification output transistor is formed as the identification signal output terminal;
the detection electrode is electrically coupled to the second electrode of the fingerprint identification reference capacitor.

8. The pixel circuit according to claim 1, wherein the light emitting module includes a light emitting element, a first light emitting auxiliary transistor, a second light emitting auxiliary transistor, and a light emitting auxiliary capacitor;
a gate electrode of the first light emitting auxiliary transistor is electrically coupled to a first electrode of the light emitting auxiliary capacitor, a first electrode of the first light emitting auxiliary transistor is formed as an input terminal of the light emitting module, and a second electrode of the first light emitting auxiliary transistor is electrically coupled to the light emitting element;
a gate electrode of the second light emitting auxiliary transistor is electrically coupled to a second data input control terminal, a first electrode of the second light emitting auxiliary transistor is electrically coupled to the first electrode of the light emitting auxiliary capacitor, a second electrode of the second light emitting auxiliary transistor is electrically coupled to a second data input terminal, and a second electrode of the light emitting auxiliary capacitor is electrically coupled to the reference level signal terminal.

9. A driving method of the pixel circuit of claim 1, the driving method comprising a plurality of driving periods, and each driving period comprises a main light emitting period comprising:
in a sub-stage of data writing and resetting the fingerprint identification module, providing an effective signal to the first data input control terminal so as to write a data voltage into the light emitting driving module through the first data input terminal and reset the fingerprint identification module;
in a sub-stage of light emitting and fingerprint identification, providing an effective signal to the light emitting control terminal, so that the light emitting driving module is electrically coupled to the light emitting module, and the identification signal output terminal is capable of outputting a signal.

10. The driving method according to claim 9, wherein the light emitting module of the pixel circuit comprises a light emitting element, a first light emitting auxiliary transistor, a second light emitting auxiliary transistor, and a light emitting auxiliary capacitor, a gate electrode of the first light emitting auxiliary transistor is electrically coupled to a first electrode of the light emitting auxiliary capacitor, a first electrode of the first light emitting auxiliary transistor is formed as an input terminal of the light emitting module, a second electrode of the first light emitting auxiliary transistor is electrically coupled to an anode of the light emitting element, a gate electrode of the second light emitting auxiliary transistor is electrically coupled to a second data input control terminal, a first electrode of the second light emitting auxiliary transistor is electrically coupled to the first electrode of the light emitting auxiliary capacitor, a second electrode of the second light emitting auxiliary transistor is electrically coupled to a second data input terminal, and a second electrode of the light emitting auxiliary capacitor is electrically coupled to a reference level signal terminal, each driving period further comprises at least one auxiliary light emitting stage performed after the main light emitting stage,
the main light emitting stage further comprises:
in a sub-stage of display duty enable input and fingerprint collection between the sub-stage of data writing and resetting the fingerprint identification module and the sub-stage of light emitting and fingerprint identification, providing an effective control signal to the gate electrode of the second light emitting auxiliary transistor and providing an effective data signal to the second electrode of the second light emitting auxiliary transistor through the second data input terminal, so as to write the data signal input by the second data input terminal into the light emitting auxiliary capacitor,
the auxiliary light emitting stage comprises:
in a first auxiliary light emitting sub-stage, providing an effective control signal to the gate electrode of the second light emitting auxiliary transistor through the second data input control terminal, and providing an effective data signal to the second electrode of the second light emitting auxiliary transistor through the second data input terminal, so as to write the data signal input by the second data input terminal into the light emitting auxiliary capacitor;
in a second auxiliary light emitting sub-stage, providing an effective light emitting control signal to the light emitting control terminal so as to control the light emitting element to be electrically coupled to the driving sub-module.

11. A display panel, comprising a plurality of pixel units, each pixel unit is provided with a pixel circuit, and the pixel circuit in at least one of the pixel units is the pixel circuit according to claim 1.

12. A display panel, comprising a plurality of pixel units, wherein the pixel units are arranged in rows and columns,
only each pixel unit in an odd-numbered row is provided with the pixel circuit according to claim 1; or
only each pixel unit in an even-numbered row is provided with the pixel circuit according to claim 1.

13. A display panel, comprising a plurality of pixel units, wherein the pixel units are arranged in rows and columns,
pixel circuits according to claim 1 are provided in every predetermined number of pixel units in any row.

14. A display panel, comprising a plurality of pixel units, wherein the pixel units are arranged in rows and columns,
pixel circuits according to claim 1 are provided in every predetermined number of pixel units in any row,
the display panel further comprises a plurality of fingerprint identification detection lines, wherein the pixel units including the pixel circuits according to claim 1 are arranged in a matrix,
a plurality of columns of pixel units comprising the pixel circuits according to claim 1 are in one-to-one correspondence with the fingerprint identification detection lines, and identification signal output terminals of the pixel circuits in a same column are electrically coupled to a same corresponding one of the fingerprint identification detection lines.

15. A pixel circuit, comprising a data writing transistor, a driving transistor, a compensation capacitor, a compensation transistor, a reset transistor, a first light emitting control transistor, a second light emitting control transistor, a light emitting diode, a first light emitting auxiliary transistor, a second light emitting auxiliary transistor, a light emitting auxiliary capacitor, a fingerprint identification reference capacitor, an identification output transistor, a signal reset transistor, an amplifying transistor and a detection electrode,
a first electrode of the data writing transistor is electrically coupled to a first data input terminal, a second electrode of the data writing transistor is electrically coupled to a first electrode of the driving transistor, a gate electrode of the data writing transistor is electrically coupled to a first data input control terminal,
a gate electrode of the driving transistor is electrically coupled to a first electrode of the compensation capacitor, a second electrode of the compensation capacitor is electrically coupled to a high level signal terminal, a gate electrode of the compensation transistor is electrically coupled to the first data input control terminal, a first electrode of the compensation transistor is electrically coupled to the gate electrode of the driving transistor, and a second electrode of the compensation transistor is electrically coupled to a second electrode of the driving transistor,
a first electrode of the reset transistor is electrically coupled to an initial level signal terminal, a second electrode of the reset transistor is electrically coupled to the gate electrode of the driving transistor, a gate electrode of the reset transistor is electrically coupled to a reset signal terminal,
a gate electrode of the first light emitting control transistor is electrically coupled to a light emitting control terminal, a first electrode of the first light emitting transistor is electrically coupled to the high level signal terminal, a second electrode of the first light emitting control transistor is electrically coupled to the first electrode of the driving transistor,
a gate electrode of the second light emitting control transistor is electrically coupled to the gate electrode of the first light emitting control transistor, a first electrode of the second light emitting control transistor is connected to the second electrode of the driving transistor, a second electrode of the second light emitting control transistor is electrically coupled to a first electrode of the first light emitting auxiliary transistor,
a gate electrode of the first light emitting auxiliary transistor is electrically coupled to a first electrode of the light emitting auxiliary capacitor, a second electrode of the first light emitting auxiliary transistor is electrically coupled to an anode of the light emitting diode,
a gate electrode of the second light emitting auxiliary transistor is electrically coupled to a second data input control terminal, a first electrode of the second light emitting auxiliary transistor is electrically coupled to the first electrode of the light emitting auxiliary capacitor, a second electrode of the second light emitting auxiliary transistor is electrically coupled to a second data input terminal, and a second electrode of the light emitting auxiliary capacitor is electrically coupled to a reference level signal terminal,
a cathode of the light emitting diode is grounded,
a first electrode of the fingerprint identification reference capacitor is electrically coupled to the high level signal terminal, a second electrode of the fingerprint identification reference capacitor is electrically coupled to a first electrode of the signal reset transistor and a gate electrode of the amplifying transistor,
a first electrode of the amplifying transistor is electrically coupled to a first electrode of the identification output transistor, a second electrode of the amplifying transistor is electrically coupled to the reference level signal terminal,
a gate electrode of the signal reset transistor is electrically coupled to the first data input control terminal, and a second electrode of the signal reset transistor is electrically coupled to the reference level signal terminal;
a gate electrode of the identification output transistor is electrically coupled to the light emitting control terminal, and a second electrode of the identification output transistor is electrically coupled to a fingerprint identification detection line;
a detection electrode is electrically coupled with the second electrode of the fingerprint identification reference capacitor.
